(19) United States
(12) Patent Application Publication
(10) Pub. No.: US 2023/0233959 A1
(43) Pub. Date: Jul. 27, 2023

(54) RECIRCULATION SYSTEM AND METHOD FOR A SETTLING TANK, IN PARTICULAR A CLARIFIER OF A PURIFICATION PLANT

(71) Applicant: CLARIF-CONCEPT, Villeneuve-les-Maguelone (FR)

(72) Inventor: Gilles, Constant, Auguste Galichet, Villeneuve-les-Maguelone (FR)

(73) Assignee: CLARIF-CONCEPT, Villeneuve-les-Maguelone (FR)

(21) Appl. No.: 17/923,286

(22) PCT Filed: May 27, 2021
(86) PCT No.: PCT/IB2021/054630

§ 371 Date: Nov. 4, 2022

(30) Foreign Application Priority Data
May 28, 2020 (EP) 20315269.9

(51) Int. Cl. B01D 21/00; B01D 21/24; C02F 3/12

(52) U.S. Cl. CPC B01D 21/0087; B01D 21/0042; B01D 21/2427; B01D 21/2405; C02F 3/1236

(57) ABSTRACT

The system (1) for accelerating settling in a settling tank (2) by recirculation of slowly sedimenting fine particles uses the Venturi effect caused by coaxial deflectors (14, 14′, 15, 24) promoting the agglomeration of particles in laminar currents (F1-F4) bringing them into contact with the sludge (3) of the main current (C1) entering into the system (1), which is entrained by the centripetal counter currents (C3) generated within the settling tank (2) towards the bottom (7) of the settling tank.

The invention relates to the field of treating effluent, generally waste water, in particular in purification stations.

An object of the present invention is to provide a system which enables the recirculation of effluent within a settling tank, in particular a clarifier of a purification station, and which optimizes the settlement of sludge in the settling tank, which sludge involves sediments in suspension in the effluent in question.

A clarifier of a purification station is the last element for treating the effluent before the treated and clarified water is released into the environment. The clarifier receives upstream effluent which originates from an activation basin and which has been pretreated with activation bacteria. This pretreated effluent, on arrival in the clarifier, is charged with activation bacteria which have digested the last organic material in suspension and which have precipitated to form the activation sludge. The clarifier therefore serves to separate the activation sludge and to clarify the water which will be released by means of overflow into the environment.

In known manner, a clarifier is a generally circular basin which comprises a frustoconical bottom wall and which can be inclined toward the center of the clarifier, and a central technical well which extends from the bottom of the clarifier toward the surface thereof. This technical well comprises a supply of activated effluent which is accommodated below and close to the surface of the clarifier. In the case of a clarifier of the scraper type, it further comprises a scraper bridge which periodically sweeps the bottom in order to move the sludge which has settled at the bottom to an outlet for recovering the activated sludge. Finally, the clarifier comprises a spillway in order to enable the overflow of clarified water.

In order to facilitate the clarification of the effluent and to prevent the release of pollutants into the environment, it is necessary for the agglomeration of the sludge to be efficient and for the dwell time of the effluent in the clarifier not to be excessively long in order to prevent the lysis of bacteria present in the activation sludge, which would bring about a release of the pollution captured by these bacteria.

There are known devices which are generally referred to as “Clifford” devices and which comprise a skirt which is arranged around the technical well in the region of the supply of activated effluent. This skirt serves to direct the effluent flow toward the bottom of the clarifier.

However, these devices do not prevent the formation of floating sludge which is consequently at risk of overflowing into the environment.

There is also known from the European Patent EP 2296774 a clarifier which comprises sludge guiding means which are constituted by a plurality of coaxial skirts which are arranged around the technical well and which enable the centripetal recirculation currents to be placed into contact with centrifugal outlet currents in order to facilitate the agglomeration of the sludge.

However, this solution can generate turbulence in the clarifier, which risks counteracting the agglomeration of the sludge. On the other hand, these recirculations, although they improve the problem set out above, do not completely eliminate the presence of floating sludge.

In order to overcome the various disadvantages set out above, an object of is the invention is to provide an effluent recirculation system which optimizes the agglomeration and the settling of the sludge within a settling tank.

To this end, the invention relates to a recirculation system fora settling tank, which settling tank comprises a basin and supply means for supplying to the basin effluent which is charged with sludge in suspension, which supply means comprise an effluent outlet below and close to the surface of the basin, which recirculation system comprises;
means for orientated guiding of the effluent current charged with sludge from the outlet of the supply means in the direction of the bottom of the basin;
means for concentrating the orientated effluent current arranged at the outlet of the guiding means in order to generate a laminar effluent flow;
first acceleration means the laminar flow which are adjacent to an outlet of the concentration means, and
deflection means the accelerated flow toward the surface of the basin of the settling tank in order to generate a deflected flow.

The recirculation system may also comprise the following optional features, considered in isolation or in accordance with any possible technical combination:
the concentration means comprise a frustoconical inner skirt which is capable of being arranged around the effluent supply means and a frustoconical outer skirt which is fixedly joined to the guiding means, which inner and outer skirts provide an annular concentration space which has in radial section a frustoconical shape which extends in a convergent manner toward the outlet of the concentration means.
The first acceleration means comprise a first frustoconical skirt which is capable of being arranged around the effluent supply means, which first frustoconical skirt is arranged at the outlet of the concentration means providing a first annular space which is delimited by the first frustoconical skirt and the frustoconical inner skirt of the concentration means, which first annular space has in radial section a shape which converges as far as a so first annular opening.
The deflection means comprise the first frustoconical skirt which extends in a divergent manner in the direction of the surface of the basin of the settling tank in order to deflect the accelerated flow toward the surface.
The system comprises second acceleration means the accelerated flow arranged between the first acceleration means and the deflection means in order to generate a secondarily accelerated flow.
The second acceleration means comprise a second frustoconical skirt which is capable of being arranged around the effluent supply means and which is arranged remote from the first frustoconical skirt providing a second annular space which is delimited by the first frustoconical skirt and the second frustoconical skirt and which has in radial section a shape which converges as far as a second annular opening.
The first frustoconical skirt extends in a divergent manner in the direction of the bottom of the basin of the settling tank, and the deflection means the laminar flow comprise the second frustoconical skirt which extends in a divergent manner in the direction of the surface of the basin in order to deflect the secondarily accelerated flow toward the surface.
The concentration means have in cross section a frustoconical shape which extends in a divergent manner from the outlet thereof.
The guiding means comprise a frustoconical body which extends in a divergent manner from the concentration means.
The guiding means comprise a cylindrical body which extends from the concentration means.

The invention also relates to a settling tank of the clarifier type for a purification station which comprises a basin for storing effluent charged with sludge, in particular activated purification sludge, comprising effluent supply means which comprise an effluent outlet below and close to the surface of the basin, which settling tank further comprises a recirculation system which is arranged around the supply means and which comprises:
means for orientated guiding of the effluent current charged with sludge from the outlet of the supply means in the direction of the bottom of the basin;
means for concentrating the orientated effluent current which are arranged at the outlet of the guiding means in order to generate a laminar effluent flow;
first acceleration means the laminar flow which are adjacent to an outlet of the concentration means, and
deflection means the accelerated flow toward the surface of the basin of the settling tank in order to generate a deflected flow.

The settling tank may also comprise the following optional features, considered in isolation or in accordance with any possible technical combination:
the effluent supply means form a column which extends perpendicularly from the bottom of the basin and which comprises in the region of a free end portion the effluent outlet which is arranged below and close to the surface of the basin, the effluent outlet comprises an opening of annular form in order to discharge the effluent in all directions, and the supply column and the recirculation system are coaxial, the effluent outlet comprises a plurality of reinforcement elements which are distributed in a uniform manner and each reinforcement element extends through the opening parallel with the effluent supply column.
The effluent outlet comprises four reinforcement elements.
The concentration means comprise a frustoconical inner skirt which is capable of being arranged around the effluent supply means and a frustoconical outer skirt which is fixedly joined to the guiding means, which inner and outer skirts provide an annular concentration space which has in radial section a frustoconical shape which extends in a convergent manner toward the outlet of the concentration means.
The first acceleration means comprise a first frustoconical skirt which is capable of being arranged around the effluent supply means, which first frustoconical skirt is arranged at the outlet of the concentration means providing a first annular space which is delimited by the first frustoconical skirt and the frustoconical inner skirt of the concentration means, which first annular space has in radial section a shape which converges as far as a first annular opening.
The deflection means comprise the first frustoconical skirt which extends in a divergent manner in the direction of the surface of the basin of the settling tank in order to deflect the accelerated flow toward the surface.
The system comprises second acceleration means for the accelerated flow, which are arranged between the first acceleration means and the deflection means in order to generate a secondarily accelerated flow.
The second acceleration means comprise a second frustoconical skirt which is capable of being arranged around the effluent supply means and which is arranged remote from the first frustoconical skirt providing a second annular space which is delimited by the first frustoconical skirt and the second frustoconical skirt and which has in radial section a shape which converges as far as a second annular opening.
The first frustoconical skirt extends in a divergent manner in the direction of the bottom of the basin of the settling tank, and the deflection means the laminar flow comprise the second frustoconical skirt which extends in a divergent manner in the direction of the surface of the basin on order to deflect the secondarily accelerated flow toward the surface.
The concentration means have in cross section a frustoconical shape which extends in a divergent manner from the outlet thereof.
The guiding means comprise a body having a frustoconical shape which extends in a divergent manner from the concentration means.
The guiding means comprise a cylindrical body which extends from the concentration means.

The invention finally relates to a method for recirculating effluent charged with sludge in a settling tank, in particular a clarifier fora purification station, comprising a basin for storing effluent charged with sludge, effluent supply means which comprise an effluent outlet below and close to the surface of the basin, which settling tank further comprises a recirculation system which is arranged around the supply means and which comprises means for orientated guiding of the effluent current charged with sludge from the outlet of the supply means in the direction of the bottom of the basin, means for concentrating the orientated effluent current arranged at the outlet of the guiding means in order to generate a laminar effluent flow, first acceleration means the laminar flow which are adjacent to an outlet of the concentration means, and deflection means the accelerated flow toward the surface of the basin of the settling tank, which method comprises the successive steps of:
orientated guiding of the effluent current from the outlet of the supply means in the direction of the bottom of the basin;
generating a laminar effluent flow by concentrating the orientated effluent flow at the outlet of the concentration means;
first acceleration of the laminar flow at the outlet of the concentration means, and
deflecting the accelerated laminar flow toward the surface of the basin in order to generate a deflected flow.

The recirculation method may also comprise the following optional features considered in isolation or in accordance with any possible technical combination:
the method comprises a step of second acceleration of the accelerated laminar flow in order to generate a secondarily accelerated flow prior to the deflection thereof toward the surface of the basin.

Other features and advantages of the invention will be appreciated clearly from the description which is set out below, by way of indication and in a non-limiting manner, with reference to the appended Figures, in which:

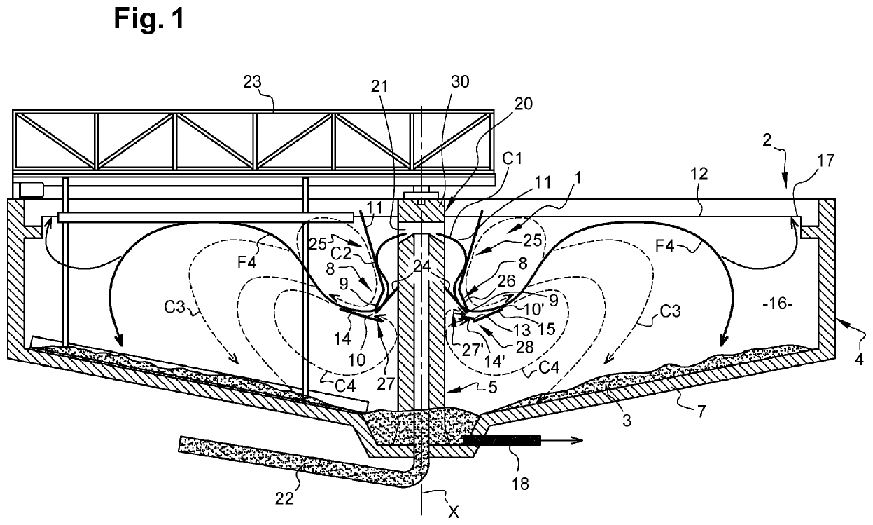

FIG. 1 shows a radial section of a clarifier comprising in the left portion of the Figure a first embodiment of a recirculation system according to the invention and in the right portion a second embodiment of the recirculation system according to the invention;

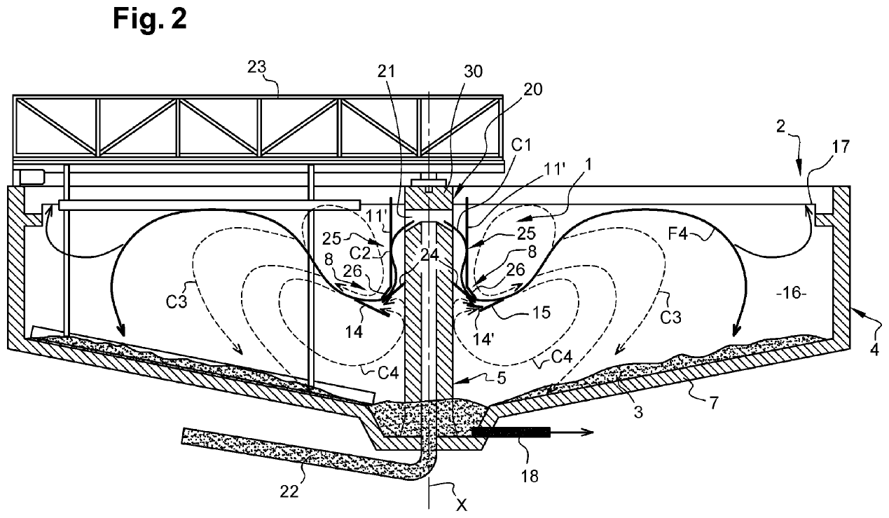

FIG. 2 shows a radial section of a clarifier comprising in the left portion of the Figure a variant of the first embodiment of the recirculation system of FIG. 1 and in the right portion a variant of the second embodiment of the recirculation system of FIG. 1;

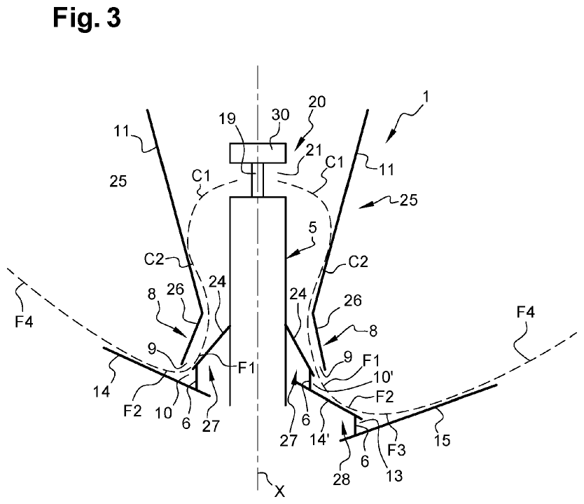

FIG. 3 shows a detail of FIG. 1 illustrating the recirculation system according to the first and second embodiments;

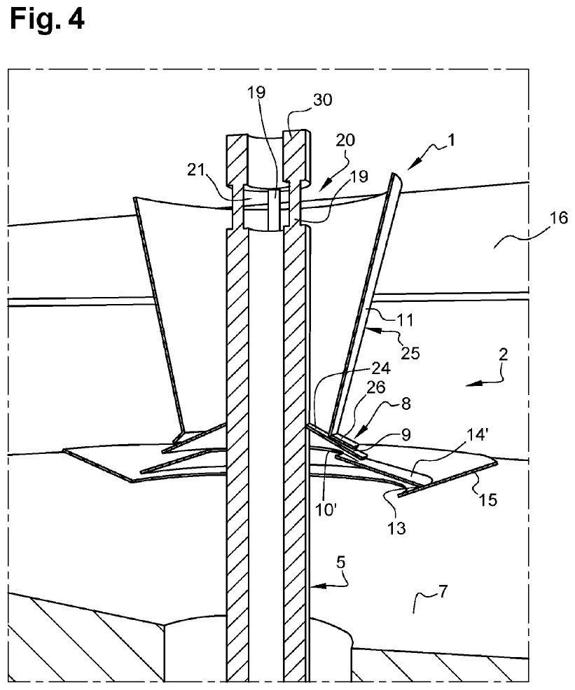

FIG. 4 shows a perspective view and a radial section of the recirculation system according to the second embodiment of FIG. 1.

It is first of all set out that that, in the Figures, the same reference numerals refer to the same elements regardless of the Figure in which they appear and regardless of the form in which these elements are illustrated. In the same manner, if elements are not specifically referred to in one of the Figures, their reference numerals may be easily found by referring to another Figure.

It is also set out that the Figures illustrate substantially two embodiments of the subject-matter of the invention but other embodiments which comply with the definition of the invention may exist.

The invention relates to the field of treating effluent which comprises so sediments in suspension which are generally referred to as sludge. In particular, the invention will be set out within the context of treating waste water in purification stations.

Purification stations comprise a series of treatment means which are intended to treat waste water which originates from the sewers in order to allow them is to be released into the environment.

In known manner, a method for treating waste water is carried out within a purification station in accordance with successive steps of screening in order to eliminate the majority of solid waste, sieving for the smaller solid waste, removal of grit and removal of oil, lamellar settling in order to eliminate the last particles in suspension, aeration in an aerator and finally clarification in one or more clarifiers 2.

In the aerator the aerobic bacteria which are referred to as activation bacteria break down the organic matter present in the water during treatment. This decomposed organic matter is converted into activated sludge 3.

At the end of the treatment line for waste water, the clarifier(s) 2 receive(s) from the aerator water comprising this activated sludge 3. In the remainder of the description, the term “activated effluent” will be used to refer to the effluent which originates from the aerator and which is charged with activated purification sludge 3 formed by organic matter which has been decomposed by the activation bacteria.

The clarifier 2 is a settling tank and its function is to separate the activated sludge 3 from the remainder of the activated effluent in order to enable the clarified water 16 to be released into the environment.

With reference to FIGS. 1 and 2, a clarifier 2 comprises a storage basin 4 for activated effluent which is generally of cylindrical form and which comprises a substantially frustoconical bottom wall 7 and a spillway 17 which is arranged at the edge of the basin 4 over the entire circumference thereof in order to enable discharge by means of overflow of the clarified water 16. The frustoconical shape of the bottom wall 7 is non-limiting and the clarifier 2 may in some variants comprise a bottom wall 7 which is planar and perpendicular relative to the cylindrical wall of the basin 4.

The clarifier 2 also comprise a technical well 5 which is in the form of a column which extends perpendicularly from the bottom 7 of the basin 4 and inside which a pipe 22 for supplying the activated effluent originating from the aerator extends. The column 5 is preferably cylindrical and forms means for supplying the activated effluent. A first end of the column 5 is fixedly joined to the bottom 7 of the basin 4 whilst an opposing end portion comprises an outlet 20 for activated effluent which comprises an annular opening 21 which is arranged below and close to the surface 12 of the basin 4 in order to ensure a homogeneous and isotropic distribution of the activated effluent in the basin 4. Furthermore, the free end of the column 5 preferably protrudes from the basin 4.

The clarifier 2 also comprises a scraper bridge 23 which is fixed to the free end of the column and which is capable of being rotatably driven in order to scrape the bottom 7 of the basin 4. The scraper bridge 23 thus has the function of scraping the sludge 3 which has settled at the bottom 7 of the basin 4 in order to move it toward the center of the basin 4. The clarifier 2 finally comprises a discharge pipe 18 for the activated sludge 3 which opens in the center of the basin 4.

According to the invention and with reference to FIGS. 3 and 4, the activated effluent outlet 20 comprises four reinforcement elements 19 which are uniformly distributed and which extend through the opening 21 in a direction perpendicular to the column 5 for supplying activated effluent and which support a plate 30 of the column 5 whose upper face forms the end of the column 5. These reinforcement elements 19 which are preferably cylindrical enable the scraper bridge 23 which is connected to the plate 30 to be supported, whilst the arrangement of the reinforcement elements 19 influences neither the homogeneity nor the isotropy of the distribution of activated effluent in the basin 4.

Finally and according to the invention, the clarifier 2 comprises a system 1 for recirculation of activated effluent and settling of the activated sludge 3. The recirculation system 1 is arranged at least partially below the surface 12 of the basin 4 of the clarifier 2 around the column which forms the technical well 5, the recirculation system 1 and the column 5 being coaxial.

The recirculation system 1 according to the invention will now be described with reference to FIGS. 1 to 4.

The recirculation system 1 comprises means 11, 11′ for orientated guiding of the effluent current C1 leaving the technical column 5, which guiding means 11, 11′ are arranged in a coaxial manner around the technical column 5.

The recirculation system 1 further comprises means 8, 24, 26 for concentrating the orientated effluent flow originating from the outlet of the orientated guiding means 11, 11′. The concentration means 8, 24, 26 comprise a first wall 24, referred to as an inner wall, which is in the form of a frustoconical skirt whose inner circumferential edge is fixedly joined to the column 5 and which extends in a divergent manner from this inner circumferential edge toward the bottom 7 of the basin 4. The concentration means 8, 24, 26 also comprise a frustoconical outer skirt 26 which is arranged opposite the inner skirt 24. This outer skirt 26 is further arranged coaxially around the technical column 5 and is fixedly joined to an end of the main body 11, 11′. The outer skirt 26 and the main body 11, 11′ form a second wall 25 which is referred to as the outer wall.

Furthermore, the opposite free end of the main body 11, 11′ is in alignment with the surface 12 of the basin 4. Preferably, the free end of the main body 11, 11′ protrudes. According to a first variant which is illustrated in FIGS. 1 and 3, the main body 11 is frustoconical and extends in a convergent manner from the free end thereof to the bottom 7 of the basin 4. According to a second variant which is illustrated in FIGS. 2 and 4, the main body 11′ is cylindrical. In these two variants, the main body 11, 11′ surrounds the technical column 5 in a coaxial manner.

Finally, the generatrixes of the main body 11, 11′ and the outer skirt 26, respectively, are secant so that, once installed around the column 5, the outer skirt 26 extends in divergent manner from the connection edge thereof with the main body 11, 11′ toward the bottom 7 of the basin 4.

The respective inner skirt 24 and outer skirt 26 are fixedly joined together by means of connection elements 6 which ensure that the two skirts 24, 26 are kept apart from each other in order to provide a space between the two skirts and opening which forms the outlet 9 of the concentration means 8, 24, 26. The connection elements 6 are, for example, plates whose two opposing edges are fixedly joined to the upper face of the outer skirt 26 and the lower face of the inner skirt 24, respectively.

In the remainder of the description, the term “lower” is used for any face which is orientated toward the bottom 7 of the basin 4, whilst the term “upper” is used for any face which is orientated toward the surface 12 of the basin 4.

The annular concentration space formed between the two skirts 24, 26 has in radial section a frustoconical shape which extends in a convergent manner toward the outlet 9 of the concentration means 8, 24, 26, which outlet 9 is annular and is delimited by the free edges of the two skirts 24, 26. Both the inner skirt 24 and the outer skirt 26 which are connected together thus form the concentration means 8, 24, 26 of the recirculation system 1 whose function will be described below.

The recirculation system 1 also comprises acceleration means and deflection means 14, 15 for the flow of activated effluent which will be described according to two different embodiments.

With reference to FIGS. 1 to 3 and according to a first embodiment, the recirculation system 1 comprises a frustoconical skirt 14 which is referred to as an is acceleration and deflection skirt.

FIGS. 1 to 3 each show a radially sectioned view of a clarifier comprising a recirculation system 1 according to the invention. In the left portion of FIGS. 1 to 3, the first embodiment of the system is illustrated, whilst in the right portion of these FIGS. 1 to 3, the second embodiment of the reticulation system is illustrated. In each Figure, the two embodiments are separated by an axis X which merges with the directrix of the column 5.

This acceleration and deflection skirt 14 is arranged in a coaxial manner around the technical column 5 and is fixedly joined to the inner skirt 24 of the concentration means 8 by connection elements 6, such as those described above: two opposing edges of each connection element 6 are fixedly joined to a lower face of the inner skirt 24 and an upper face of the acceleration and deflection skirt 24, respectively.

These connection elements keep the skirts 14, 24 away from each other in order to form an annular acceleration space 27 which is delimited by the lower face of the inner skirt 24 and the upper face of the acceleration and deflection skirt 14, which acceleration space 27 has in radial section a frustoconical shape which converges toward an annular acceleration opening 10 which is delimited by the upper face of the acceleration and deflection skirt 14 and the free edge of the inner skirt 24.

Furthermore, the acceleration and deflection skirt 14 extends in a divergent manner toward the surface 12 of the basin 4 and the function thereof will be set out below in the description.

In this embodiment, the relative arrangement of the inner skirt 24 and the acceleration and deflection skirt 14, thus generating the annular space 27 which converges toward the annular outlet 10, forms the first acceleration means of the recirculation system 1. Furthermore, the divergent configuration of the frustoconical skirt 14 in the direction of the surface 12 of the basin forms the deflection means of the recirculation system 1.

A method for recirculating activated effluent and settling the activated sludge 2, carried out by the recirculation system 1 according to the first embodiment, will now be described.

The activated effluent is conveyed via the supply pipe 22 which is connected to the activator and which opens in the technical column 5, then is discharged into the basin 4 via the supply opening 21 which is arranged in the region of the outlet 20 of the column 5. The activated effluent therefore arrives between the column 5 and the upper portion of the outer wall 25 which forms the guiding means, that is to say, in the main body 11, 11′whose function is to redirect the effluent current C1 downward, that is to say, in the direction of the bottom 7 of the basin 4, in order to generate an orientated effluent current C2. In the remainder of the description, a current or a flow is said to be directed downward when it is orientated toward the bottom 7 of the basin 4, whilst a current or a flow is directed upward when it is orientated toward the surface 12 of the basin 4.

The orientated effluent current C2 in the main body 11, 11′ is therefore directed toward the concentration means 8, 24, 26 of the recirculation system 1. These concentration means 8, 24, 26, whose cross section decreases progressively as far as the outlet 9 thereof, serves to concentrate the effluent current C2 so that the effluent flow F1 obtained at the outlet 9 is made laminar by the concentration means 8, 24, 26.

A flow is said to be laminar when all of the current lines of the flow flow in the same direction. Consequently, such a laminar flow has no turbulence and eddy currents which would conflict with the settling process of the activated sludge 3.

At the outlet 9 of the concentration means 8, 24, 26, the laminar effluent flow F1 which is directed toward the upper surface of the acceleration and deflection skirt 14 is reorientated by the skirt 14 toward the surface 12 of the basin 4. The deflected laminar flow F4 is thus directed toward the surface 12 and toward the outer side of the basin 4. As the flow F4 moves toward the lateral edges of the basin 12, it is redirected toward the bottom 7 of the basin 4 and brings about the sedimentation of the sludge 3 at the bottom 7. Furthermore, centripetal counter-currents C3 which are generated in the settling tank 2 are also redirected in the direction of the bottom 7 of the basin 4 in order to enable the sedimentation of the particles in suspension.

A portion of the deflected flow F4 further generates counter-currents C4 which are redirected toward the technical column 5, recirculate in the annular acceleration space 27 and leave via the annular opening 10 of the recirculation system 1.

The counter-currents C4 which penetrate into this annular acceleration space 27 are also subjected to a reduced pressure which is linked to the Venturi effect, which brings about the aggregation of the finest sediments present in the sludge 3.

The flow originating from this acceleration space 27 is accelerated by the is Venturi effect to a speed in the order of 20 centimeters per second and leaves via the annular acceleration opening 10 while accelerating the laminar flow F1 which is leaving the concentration means 8, 24, 26 and thus generating an accelerated laminar flow F2. This accelerated flow F2 will then be deflected by the skirt 14 in order to generate the deflected flow F4

These acceleration means 14, 24; 10, 27 thus enable, on the one hand, the speed of the recirculation flow to be increased in particular in the region of the surface 12 of the basin 4, which results in the accumulation of floating sludge being prevented and consequently facilitates the settling at the bottom of the basin 4 of the activated sludge 3, and, on the other hand, the agglomeration of the finest sludge 3 to be facilitated, accelerating the settling thereof at the bottom of the basin 4.

Furthermore, the accelerated flow F2 which opens from the annular acceleration outlet 10 enables any accumulation of sludge 3 on the upper face of the acceleration and deflection skirt 14 to be prevented and thus enables an optimum effluent flow to be maintained in the basin 4.

With reference to FIGS. 1 to 4 and in accordance with a second embodiment, the recirculation system 1 comprises a first frustoconical skirt 14′ which is referred to as an acceleration skirt and a second frustoconical skirt 15 which is referred to as a deflection skirt.

The acceleration skirt 14′ is provided in a coaxial manner around the technical column 5 and is fixedly joined to the inner skirt 24 of the concentration means 8, 24, 26 by connection elements 6, such as those described above: two opposing edges of each connection element are fixedly joined to a lower face of the inner skirt 24 and an upper face of the acceleration skirt 14′, respectively.

These connection elements keep the skirts 14′, 24 away from each other in order to form a first annular acceleration space 27′ which is delimited by the lower face of the inner skirt 24 and the upper face of the acceleration skirt 14′, which first acceleration space 27′ has in radial section a frustoconical shape which converges toward a first annular acceleration opening 10′ which is delimited by the upper face of the acceleration skirt 14′ and by the free edge of the inner skirt 24.

The deflection skirt 15 is also arranged in a coaxial manner around the technical column 5 and is fixedly joined to the acceleration skirt 14′ by connection elements such as those described above: two opposing edges of each connection is element are fixedly joined to a lower face of the acceleration skirt 14′ and an upper face of the deflection skirt 15, respectively.

These connection elements keep the skirts 14′, 15′ apart from each other in order to form a second annular acceleration space 28 which is delimited by the lower face of the acceleration skirt 14′ and the upper face of the deflection skirt 15, which second acceleration space 28 has in radial section a frustoconical shape which converges toward a second annular acceleration opening 13 which is delimited by the upper face of the deflection skirt 15 and by the free edge of the acceleration skirt 14′.

In this embodiment, the relative arrangement of the acceleration skirt 14′ and the inner wall 24, thus creating the annular space 27′ which converges toward the annular outlet 10, forms the first acceleration means of the recirculation system 1. Furthermore, the relative arrangement of the deflection skirt 15 and the acceleration skirt 14′, thus creating the annular space 28 which converges toward the annular outlet 13, forms the second acceleration means of the recirculation system 1.

Furthermore, the acceleration skirt 14′ extends in a divergent manner toward the bottom 7 of the basin 4, whilst the deflection skirt 15 extends in a divergent manner toward the surface 12 of the basin 4 in order to generate the deflected flow F4 in the direction of the surface 12 of the basin 4.

A method for recirculating the activated effluent and settling the activated sludge 4 carried out by the recirculation system 1 according to the second embodiment will now be described.

The activated effluent is conveyed at a speed in the order of 20 centimeters per second via the supply pipe 22 which is connected to the activator and which opens in the technical column 5, then is discharged into the basin 4 via the supply opening 21 which is arranged in the region of the outlet 20 of the column 5. The activated effluent therefore arrives between the column 5 and the upper portion of the outer wall 25 forming the guiding means, that is to say, in the main body 11, 11′ whose function is to redirect the effluent current C1 downward in order to generate the orientated effluent current C2.

The orientated effluent current C2 in the main body 11, 11′ is therefore directed toward the concentration means 8, 24, 26 which will concentrate the effluent current C2 in order to generate the laminar effluent flow F1 at the outlet 9.

At the outlet 9 of the concentration means 8, 24, 26, the laminar effluent flow F1 which flows on the upper surface of the acceleration skirt 14′, then on the upper surface of the deflection skirt 15 is reorientated by the deflection skirt 15 toward the surface 12 of the basin 4. The deflected flow F4 is thus directed toward the surface 12 and toward the outer side of the basin 4. As the flow F4 moves closer to the edges of the basin 4, it is redirected toward the bottom 7 of the basin 4 and brings about the sedimentation of the sludge 3 on the bottom 7. Furthermore, centripetal counter-currents C3 generated in the settling tank 2 are also redirected in the direction of the bottom 7 of the basin 4 in order to permit the settling of the particles in suspension.

A portion of the deflected flow F4 further generates counter-currents C4 which are redirected toward the technical column 5 then recirculates toward the first and second annular acceleration spaces 27′, 28 of the recirculation system 1.

A first portion of the counter-currents C4 recirculates in the system 1 of the invention via the first annular space 27′ and the first annular opening 10′, whilst a second portion of the counter-currents C4 recirculates in the system 1 of the invention via the second annular space 28 and the second annular opening 13.

The first portion of the counter-currents C4 is accelerated by the Venturi effect and, leaving via the first annular opening 10′, contributes to accelerating the laminar flow F1 at the outlet 9 of the concentration means 8, 24, 26 and thus generating the accelerated laminar flow F2. Furthermore, the first of the counter-currents C4 penetrating into this annular acceleration space 27′ are also subjected to a reduced pressure which is linked to the Venturi effect, which brings about the aggregation of the finest sediments present in the sludge 3.

On the other hand, the second portion of the counter-currents C4 is also accelerated by the Venturi effect and, leaving via the second annular opening 13, contributes to further accelerating the laminar effluent flow flowing between the upper face of the acceleration skirt 14′ and the upper face of the deflection skirt 15, thus generating the secondarily accelerated laminar flow F3. The secondarily accelerated flow will therefore be deflected by the skirt 15 in order to generate the deflected flow F4. Furthermore, the second portion of the counter-currents C4 which penetrates into this second annular acceleration space 28 are also subjected to a reduced pressure which is linked to the Venturi effect, which brings about a second aggregation of the finest sediments present in the sludge 3.

These first acceleration means 14′, 24; 10′, 27′ thus enable, on the one hand, the speed of the recirculation flow to be increased in particular in the region of the surface 12 of the basin 4, which has the effect of preventing the presence of floating sludge and consequently facilitating the settling at the bottom 7 of the basin 4 of the activated sludge 3 and, on the other hand, the agglomeration of the finest sludge 3 to be facilitated, accelerating the settling thereof at the bottom of the basin 4.

Furthermore, the second acceleration means 14′, 15; 28, 13, in addition to further increasing the recirculation speed of the flow in the region of the surface 12 of the basin 4, thus completely eliminating the risk of floating sludge, enable any accumulation of activated sludge 3 on the upper face of the deflection skirt 15 to be prevented, and therefore enables an optimum effluent flow to be maintained in the basin 4. These second acceleration means 14′, 15; 28, 13 further accelerate the settling speed of the sludge, further increasing the efficiency of agglomeration of the finest sludge 3.

Finally, the recirculation system 1 of the invention increases the settling speed of the activated sludge 3 and enables the recovery thereof before the lysis of the bacteria present in this sludge 3. In this manner, any release into clarified water 16 of the pollutants which are captured by the bacteria and which would result from the destruction of the cellular wall of the bacteria is prevented.

The recirculation system 1 of the invention is described in connection with a clarifier 2 of a purification station for settling the purification sludge of the activated effluent, but it is understood that this recirculation system 1 can be adapted to for any type of settling tank whose function is to settle effluent in order to separate the sediments or sludge in suspension in the liquid phase of the effluent.

Furthermore, the materials which constitute the various portions of the recirculation system 1 of the invention may be adapted in accordance with the application. By way of non-limiting example, the recirculation system 1 may be made from high-density polyethylene (HDPE) for effluent whose temperature does not exceed 40 degrees Celsius or from stainless steel if the effluent is warmer, for example, at 90 degrees Celsius.

1. A recirculation system for a settling tank the settling tank comprising a basin and effluent supply means for supplying to the basin effluent which is charged with sludge in suspension, which supply means comprise an effluent outlet below and close to a surface of the basin, the recirculation system comprising:
orientated guide means for orientated guiding of an effluent current charged with sludge from the effluent outlet of the supply means in a direction of a bottom of the basin;
concentrator means for concentrating the orientated effluent current arranged at an outlet of the orientated guide means in order to generate a laminar flow;
first accelerator means for accelerating the laminar flow, which are adjacent to an outlet of the concentrator means in order to generate an accelerated flow, and
deflector means for deflecting the accelerated flow toward the surface of the basin of the settling tank in order to generate a deflected flow.

2. The system as claimed in claim 1, wherein the concentrator means comprise a frustoconical inner skirt which is capable of being arranged around the supply means and a frustoconical outer skirt which is fixedly joined to the orientated guide means, the inner skirt and the outer skirt providing an annular concentration space having a frustoconical in radial section, the frustoconical shape extending in a convergent manner toward the outlet of the concentrator for means.

3. The system as claimed in claim 2, wherein the first accelerator means comprise a first frustoconical skirt which is capable of being arranged around the supply means the first frustoconical skirt being arranged at the outlet of the concentrator means so as to provide a first annular space which is delimited by the first frustoconical skirt and the frustoconical inner skirt of the concentrator means in radial section, the converging shape converging as far as a first annular opening.

4. The system as claimed in claim 3, wherein the deflector means comprise the first frustoconical skirt which extends in a divergent manner in a direction of the surface of the basin of the settling tank in order to deflect the accelerated flow toward the surface of the basin.

5. The system as claimed in claim 1, wherein the system comprises second accelerator means for the accelerated flow arranged between the first accelerator means and the deflector means in order to generate a secondarily accelerated flow.

6. The system as claimed in claim 5, wherein the second accelerator means comprise a second frustoconical skirt which is capable of being arranged around the supply means and which is arranged remote from the first frustoconical skirt, so as to provide a second annular space which is delimited by the first frustoconical skirt and the second frustoconical skirt and which has a converging, shape in radial section, the converging shape converging as far as a second annular opening.

7. The system as claimed in claim 6, wherein
the first accelerator means comprise a first frustoconical skirt which is capable of being arranged around the supply means, the first frustoconical skirt being arranged at the outlet of the concentrator means so as to provide a first annular space which is delimited by the first frustoconical skirt and the frustoconical inner skirt of the concentrator means, the first annular space having a converging shape in radial section, the converging shape converging as far as a first annular opening, the first frustoconical skirt extending in a divergent manner in the direction of the bottom of the basin of the settling tank, and
the deflector means for deflecting the laminar flow comprise the second frustoconical skirt which extends in a divergent manner in direction of the surface of the basin in order to deflect the secondarily accelerated flow toward the surface.

8. The system as claimed in claim 1, wherein the concentrator means have a frustoconical shape in cross section, the frustoconical shape extending in a divergent manner from the outlet of the concentrator means.

9. The system as claimed in claim 1, wherein the orientated guide means comprise a frustoconical body which extends in a divergent manner from the concentrator means.

10. The system as claimed in claim 1, wherein the orientated guide means comprise a cylindrical body which extends from the concentrator means.

11. A settling tank which is a clarifier for a purification station, the settling tank comprising:
a basin for storing effluent charged with sludge, comprising effluent supply means having an effluent outlet below and close to a surface of the basin, and
the recirculation system as claimed in claim 1, which is arranged around the supply means,
wherein
the orientated guide means is adapted for performing orientated guiding of an effluent current charged with sludge from the effluent outlet of the supply means in a direction of a bottom of the basin;
the concentrator means is adapted for concentrating the orientated effluent current which are arranged at the outlet of the orientated guide means in order to generate a laminar flow;
the first accelerator means is adapted for accelerating the laminar flow which are adjacent to the outlet of the concentrator means in order to generate an accelerated flow, and
the deflector means is adapted for deflecting the accelerated flow toward the surface of the basin of the settling tank in order to generate a deflected flow.

12. The settling tank as claimed in claim 11, wherein
the supply means form a supply column which extends perpendicularly from the bottom of the basin and which comprises, in a region of a free end portion, the effluent outlet which is arranged below and close to the surface of the basin,
the effluent outlet comprises an opening having an annular shape in order to discharge the effluent in all directions,
the supply column and the recirculation system are coaxial,
the effluent outlet comprises a plurality of reinforcement elements which are distributed in a uniform manner, and
each reinforcement element extends through the opening with the supply column.

13. The settling tank as claimed in the claim 12, wherein the effluent outlet comprises four reinforcement elements.

14. A method for recirculating effluent charged with sludge in a settling tank, the settling tank comprising:
a basin for storing effluent charged with sludge,
effluent supply means which comprise an effluent outlet below and close to a surface of the basin, and
the recirculation system as claimed in claim 1, which is arranged around the supply means
wherein the method comprises:
performing orientated guiding of the effluent current from the outlet of the supply means in a direction of the bottom of the basin to form an orientated current;
generating a laminar flow by concentrating the orientated current at the outlet of the concentrator means;
performing a first acceleration of the laminar flow at the outlet of the concentrator means to generate an accelerated laminar flow, and
deflecting the accelerated laminar flow toward the surface of the basin to generate a deflected flow.

15. The recirculation method as claimed in claim 14, wherein the method performing a second acceleration of the accelerated laminar flow in order to generate a secondarily accelerated flow prior to the deflection of the secondarily accelerated flow toward the surface of the basin.

16. The system as claimed in claim 2, wherein the system comprises second accelerator means for the accelerated flow arranged between the first accelerator means and the deflector means in order to generate a secondarily accelerated flow.

17. The system as claimed in claim 16, wherein the second accelerator means comprise a second frustoconical skirt which is capable of being arranged around the supply means and which is arranged remote from the first frustoconical skirt, so as to provide a second annular space which is delimited by the first frustoconical skirt and the second frustoconical skirt and which has a converging shape in radial section, the converging shape converging as far as a second annular opening.

18. The system as claimed in claim 17, wherein
the first accelerator means comprise a first frustoconical skirt which is capable of being arranged around the supply means, the first frustoconical skirt being arranged at the outlet of the concentrator means so as to provide a first annular space which is delimited by the first frustoconical skirt and the frustoconical inner skirt of the concentrator means, the first annular space having a converging shape in radial section, the converging shape converging as far as a first annular opening, the first frustoconical skirt extending in a divergent manner in the direction of the bottom of the basin of the settling tank, and
the deflector means for deflecting the laminar flow comprise the second frustoconical skirt which extends in a divergent manner in a direction of the surface of the basin in order to deflect the secondarily accelerated flow toward the surface.

19. The system as claimed in claim 3, wherein the system comprises second accelerator means for the accelerated flow arranged between the first accelerator means and the deflector means in order to generate a secondarily accelerated flow.

20. The system as claimed in claim 19, wherein the second accelerator means comprise a second frustoconical skirt which is capable of being arranged around the supply means and which is arranged remote from the first frustoconical skirt, so as to provide a second annular space which is delimited by the first frustoconical skirt and the second frustoconical skirt and which has a converging shape in radial section, the converging shape converging as far as a second annular opening.
